(19) United States
(12) Patent Application Publication
(10) Pub. No.: US 2006/0176266 A1
(43) Pub. Date: Aug. 10, 2006

(54) Display apparatus and method of driving the same

(76) Inventors: Sang-Jin Pak, Yongin-si (KR); Myung-Woo Lee, Suwon-si (KR); Young-Ok Cha, Gwangmyeong-si (KR); Kee-Han Uh, Yongin-si (KR); Joo-Hyung Lee, Gwacheon-si (KR); Young-Jun Choi, Suwon-si (KR); Hyung-Guel Kim, Yongin-si (KR); Dong-Jin Jeong, Seoul (KR); Jong-Woung Park, Seongnam-si (KR); Man-Seung Cho, Seoul (KR)

Correspondence Address: CANTOR COLBURN, LLP, 55 GRIFFIN ROAD SOUTH, BLOOMFIELD, CT, 06002, US

(21) Appl. No.: 11/327,130

(22) Filed: Jan. 5, 2006

(30) Foreign Application Priority Data
Jan. 6, 2005 (KR) 2005-1205
Apr. 4, 2005 (KR) 2005-27863

(51) Int. Cl. G02F 1/1335

(52) U.S. Cl. 345/104; 349/12

(57) ABSTRACT

A display panel includes an array substrate, an opposite substrate and a liquid crystal layer disposed between the array substrate and the opposite substrate. A sensing array outputs an initial voltage in response to an initial thickness of the liquid crystal layer during an initializing time and a sensing voltage in response to a varied thickness of the liquid crystal layer due to external force during a sensing time. A control part compares the sensing voltage with the initial voltage, determines whether the external force is applied to the display panel, and generates information indicating a position to which the external force is applied. Thus, the display apparatus may improve sensing ability to an external signal inputted through the display panel thereof.

This application claims priority to Korean Patent Application No. 2005-1205 filed on Jan. 6, 2005 and Korean Patent Application No. 2005-27863 filed on Apr. 4, 2005, and all the benefits accruing therefrom under 35 U.S.C. §119, the contents of which are herein incorporated by reference in their entireties.

### BACKGROUND OF THE INVENTION

1. Field of the Invention

The present invention relates to a display apparatus and a method of driving the same. More particularly, the present invention relates to a display apparatus capable of improving a sensing ability to an external signal inputted through a display panel thereof and a method of driving the display apparatus.

2. Description of the Related Art

In general, a touch panel is disposed on an uppermost surface (or screen) of a display apparatus to receive input data generated when an object, for example, such as a human finger or a light pen, touches the touch panel. The touch panel senses a position where the object makes contact with the screen, and outputs a position signal corresponding to the position where the object makes contact with the touch panel, thereby operating the display apparatus.

Since the display apparatus having the touch panel does not require an additional data input apparatus (e.g., keyboard, mouse, etc.) electrically connected to the display apparatus, they have gained popularity and been widely used in various products.

However, since the touch panel is separate from the display panel and mounted on the display panel, a thickness of the display apparatus employing the touch panel increases.

### SUMMARY OF THE INVENTION

The present invention provides a display apparatus capable of improving a sensing ability to an external signal inputted through a display panel thereof.

The present invention also provides a method suitable for driving the above display apparatus.

In an exemplary embodiment, a display apparatus includes a display panel, a sensing array disposed in the display panel and a control part. The display panel includes an array substrate having a pixel electrode, an opposite substrate having a common electrode facing the pixel electrode and a liquid crystal layer disposed between the array substrate and the opposite substrate.

The sensing array outputs an initial voltage in response to an initial thickness of the liquid crystal layer during an initializing time and a sensing voltage in response to a varied thickness of the liquid crystal layer due to an external force during a sensing time. The control part compares the sensing voltage with the initial voltage to determine whether or not the external force is applied to the display panel. The control part generates information indicating a position on the display panel to which the external force is applied.

In another exemplary embodiment, a display apparatus generates an initial voltage in response to an initial thickness of a liquid crystal layer during an initializing time. The display apparatus generates a sensing voltage in response to a varied thickness of the liquid crystal layer due to an external force during a sensing time. The display apparatus compares the initial voltage with the sensing voltage to determine whether or not the external force is applied to a display panel. The display apparatus generates information indicating a position on the display panel to which the external force is applied.

In another exemplary embodiment, the display apparatus may generate accurate position information of an inputted signal based on the varied thickness of the liquid crystal layer while an external force is applied to the display panel, thereby improving a sensing ability to the external force to the display apparatus.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view showing an exemplary embodiment of a display apparatus according to the present invention;

FIG. 2 is a partially enlarged view showing an exemplary embodiment of a display area and a peripheral area of a display panel in FIG. 1;

FIG. 3 is a layout showing an exemplary embodiment of portion “A” of an array substrate in FIG. 2;

FIG. 4 is a cross-sectional view taken along line I-I′ in FIG. 3;

FIG. 5 is a layout showing an exemplary embodiment of portion “B” of an array substrate in FIG. 2;

FIG. 6 is a cross-sectional view taken along line II-II′ in FIG. 5;

FIG. 7 is a layout showing an exemplary embodiment of portion “C” of an array substrate in FIG. 2;

FIG. 8 is a layout showing an exemplary embodiment of an array substrate corresponding to portion “A” in FIG. 2 according to the present invention;

FIG. 9 is a cross-sectional view taken along line III-III′ in FIG. 8;

FIG. 10 is a block diagram illustrating an exemplary embodiment of a sensing array and a control part of the display apparatus in FIG. 1;

FIG. 11 is a circuit diagram illustrating an exemplary embodiment of the sensing array in FIG. 10;

FIG. 12 is a graph illustrating an output voltage of an exemplary embodiment of an operational amplifier in FIG. 10;

FIG. 13 is an exemplary embodiment of a circuit diagram showing a display panel according to the present invention;

FIG. 14 is a plan view showing another exemplary embodiment of a display apparatus according to the present invention;

FIG. 15 is a circuit diagram illustrating an exemplary embodiment of a sensing array and an operational amplifier in FIG. 14;

FIG. 16 is a plan view showing another exemplary embodiment of a display apparatus according to the present invention;

FIG. 17 is an exemplary embodiment of a circuit diagram illustrating a sensing array and an operational amplifier in FIG. 16; and

FIG. 18 is another exemplary embodiment of a circuit diagram illustrating a sensing array according to the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “upper,” relative to other elements or features would then be oriented as “lower” with respect to the other elements or features. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Hereinafter, the present invention will be explained in detail with reference to the accompanying drawings.

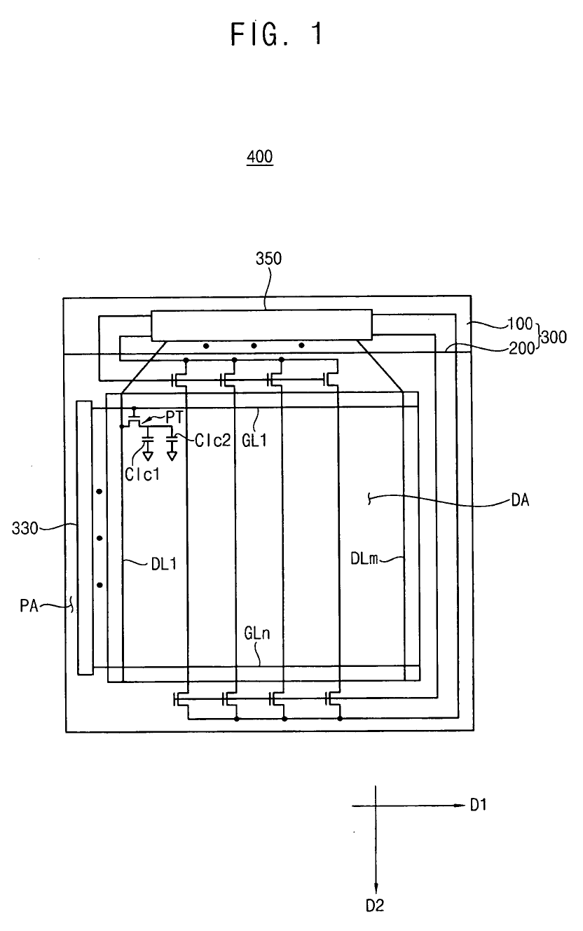

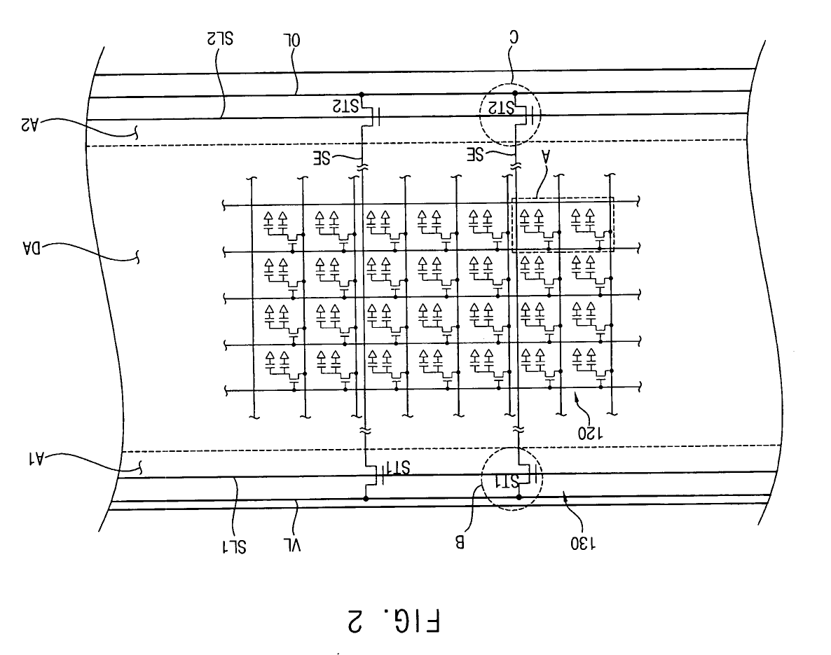

FIG. 1 is a plan view showing an exemplary embodiment of a display apparatus according to the present invention. FIG. 2 is a partially enlarged view showing an exemplary embodiment of a display area and a peripheral area of a display panel in FIG. 1.

Referring to FIGS. 1 and 2, a display apparatus 400 includes a display panel 300 having an array substrate 100, an opposite substrate 200 and a liquid crystal layer (not shown).

The array substrate 100 includes a first substrate (not shown), a pixel array 120 and a sensing array 130. The first substrate may be divided into a display area DA and a peripheral area PA adjacent to the display area DA. The pixel array 120 is formed in the display area DA of the first substrate in a substantially matrix shape. The pixel array 120 has a plurality of gate lines GL1 to GLn, a plurality of data lines DL1 to DLm, a plurality of pixel thin film transistors (TFT) PT and a plurality of pixel electrodes (not shown). The “n” of the reference “GLn” and “m” of the reference “DLm” denote positive integers.

The gate lines GL1 to GLn are extended to a first direction D1, and the data lines DL1 to DLm are extended to a second direction D2. First direction D1 and second direction D2 are shown in FIG. 1 being substantially perpendicular to each other. The gate lines GL1 to GLn are electrically insulated from and intersect with the data lines DL1 to DLm. In exemplary embodiments, each of the pixel TFTs PT is electrically connected to a corresponding gate line and a corresponding data line. For example, a first pixel TFT PT1 may include a gate electrode electrically connected to a first gate line GL1, a source electrode electrically connected to a first data line DL1 and a drain electrode electrically connected to a first pixel electrode.

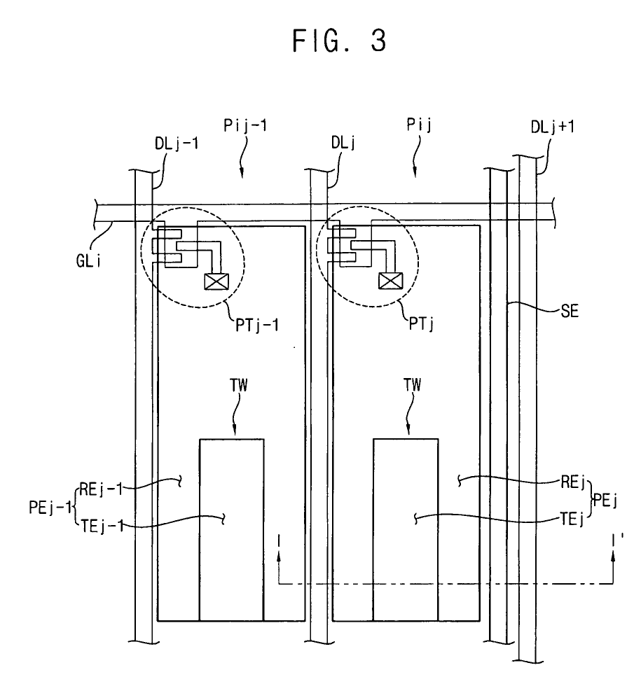

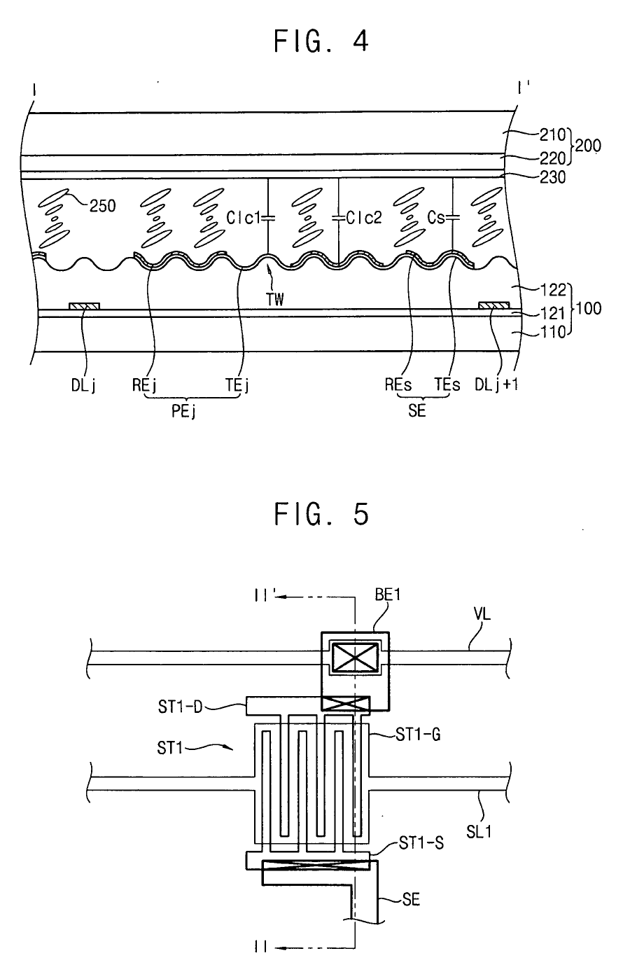

In other exemplary embodiments, each of the pixel electrodes may have a transmission electrode (not shown) and a reflection electrode (not shown). The pixel electrodes will be described below with reference to FIGS. 3 and 4.

As shown in FIGS. 1 and 2, the sensing array 130 has a sensing electrode SE, a first TFT ST1 and a second TFT ST2.

The sensing electrode SE is formed on the first substrate corresponding to the display area DA. The sensing electrode SE may include, but is not limited to, a transparent and conductive material. The sensing electrode SE may extend to the second direction D2, such that the sensing electrode SE is substantially parallel with the data lines DL1 to DLm. The first and second TFTs ST1 and ST2 are disposed in the peripheral area PA of the first substrate. The first TFT ST1 is formed in a first area A1 of the peripheral area PA adjacent to a first end portion of the data lines DL1 to DLm. The second TFT ST2 is formed in a second area A2 of the peripheral area PA adjacent to a second end portion of the data lines DL1 to DLm.

In exemplary embodiments, the sensing array 130 may further include a driving voltage line VL, a first switching line SL1, a second switching line SL2 and an output line OL. The first TFT ST1 may include a gate electrode electrically connected to the first switching line SL1, a drain electrode electrically connected to the driving voltage line VL and a source electrode electrically connected to the sensing electrode SE. In another exemplary embodiment, the second TFT ST2 may include a gate electrode electrically connected to the second switching line SL2, a drain electrode electrically connected to the sensing electrode SE and a source electrode electrically connected to the output line OL.

Referring to FIG. 1, the opposite substrate 200 includes a second substrate (not shown) and a common electrode (not shown). The common electrode may be formed on the second substrate and include, but not be limited to, a transparent and conductive material. The liquid crystal layer may be disposed between the array substrate 100 and the opposite substrate 200. The common electrode may face the pixel electrodes and the sensing electrode SE, such that the liquid crystal layer is disposed between the pixel electrodes and the common electrode and between the sensing electrode SE and the common electrode.

In exemplary embodiments, a plurality of first liquid crystal capacitors Clc1 may be defined by the common electrode, the liquid crystal layer and the transmission electrodes of the pixel electrodes. A plurality of second liquid crystal capacitors Clc2 may be defined by the common electrode, the liquid crystal layer and the reflection electrodes of the pixel electrodes. In alternative exemplary embodiments, a sensing capacitor (not shown) may be defined by the common electrode, the liquid crystal layer and the sensing electrode SE.

Referring to FIG. 1, the display apparatus 400 further includes a gate driving circuit 330 and a data driving circuit 350. The gate driving circuit 330 is electrically connected to the gate lines GL1 to GLn to sequentially output a gate signal to the gate lines GL1 to GLn. In exemplary embodiments, the gate driving circuit 330 is formed on the first substrate by a thin film process when the pixel array 120 is formed.

The data driving circuit 350 is electrically connected to the data lines DL1 to DLm to sequentially output a data signal to the data lines DL1 to DLm. In exemplary embodiments, the data driving circuit 350 may be integrated into a chip. The chip in which the data driving circuit 350 is integrated may be mounted on the first substrate corresponding to the peripheral area PA.

FIG. 3 is a layout showing portion “A” of an array substrate in FIG. 2. FIG. 4 is a cross-sectional view taken along line I-I′ in FIG. 3.

Referring to FIGS. 3 and 4, in the array substrate 100, an {i×(j−1)}-th pixel Pij−1 and an (i×j)-th pixel Pij are formed on portion “A” of the first substrate 110, wherein “i” and “j” denote positive integers.

The {i×(j−1)}-th pixel Pij−1 includes an i-th gate line GLi, a (j−1)-th data line DLj−1, a (j−1)-th pixel TFT PTj−1 and a (j−1)-th pixel electrode PEj−1. The (j−1)-th pixel electrode PEj−1 has a (j−1)-th transmission electrode TEj−1 and a (j−1)-th reflection electrode REj−1. The (j−1)-th reflection electrode REj−1 is disposed on the (j−1)-th transmission electrode TEj−1 and has a transmission window TW through which the (j−1)-th transmission electrode TEj−1 is partially exposed.

The (i×j)-th pixel Pij includes the i-th gate line GLi, a j-th data line DLj, a j-th pixel TFT PTj and a j-th pixel electrode PEj. The j-th pixel electrode PEj has a j-th transmission electrode TEj and a j-th reflection electrode REj.

In exemplary embodiments, the sensing electrode SE is formed at one side of the (i×j)-th pixel Pij. The sensing electrode SE may be disposed between the j-th pixel electrode PEj and the (j+1)-th data line DLj+1. The sensing electrode SE may include a sensing reflection electrode REs and a sensing transmission electrode TEs.

Referring to FIG. 4, the i-th gate line (not shown) including, but not limited to, a first metal material, is formed on the first substrate 110. The gate insulating layer 121 is formed on the first substrate 110 on which the i-th gate line is formed. The j-th and (j+1)-th data lines DLj and DLj+1 include, but not limited to, a second metal material, are formed on the gate insulating layer 121.

An organic insulating layer 122 is formed on the gate insulating layer 121 and the j-th and (j+1)-th data lines DLj and DLj+1. In exemplary embodiments, a plurality of concave-convex portions may be formed on the organic insulating layer 122 by an embossing process. The j-th transmission electrode TEj and the sensing transmission electrode TEs may be formed on the organic insulating layer 122 in a uniform thickness. In other exemplary embodiments, the j-th transmission electrode TEj and the sensing transmission electrode TEs may include a transparent and conductive material.

The j-th reflection electrode REj may be formed on the j-th transmission electrode TEj in a uniform thickness. The sensing reflection electrode REs may also be formed on the sensing transmission electrode TEs in a uniform thickness. In exemplary embodiments, the j-th reflection electrode REj and the sensing reflection electrode REs may include, but are not limited to, a metal material having high reflectance. The transmission window TW is formed through the j-th reflection electrode REj, through which the j-th transmission electrode TEj is partially exposed.

Referring to FIG. 4, the opposite substrate 200 includes a second substrate 210, a color filter layer 220 and a common electrode 230. The color filter layer 220 may have a red color pixel, a green color pixel and a blue color pixel formed on the second substrate 210. The common electrode 230 may be formed on the color filter layer 220 in a uniform thickness.

The liquid crystal layer 250 is disposed between the array substrate 100 and the opposite substrate 200. The first liquid crystal capacitor Clc1 includes the common electrode 230, the liquid crystal layer 250 and the j-th transmission electrode TEj. The second liquid crystal capacitor Clc2 includes the common electrode 230, the liquid crystal layer 250 and the j-th reflection electrode REj. The sensing capacitor Cs includes the common electrode 230, the liquid crystal layer 250 and the sensing electrode SE.

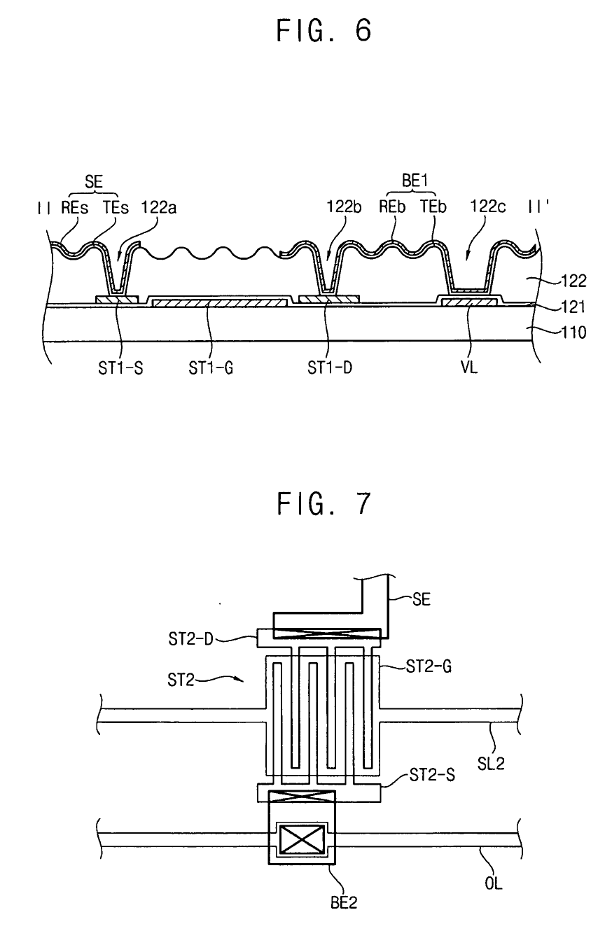

FIG. 5 is a layout showing portion “B” of an array substrate in FIG. 2. FIG. 6 is a cross-sectional view taken along line II-II′ in FIG. 5.

Referring to FIGS. 5 and 6, in the array substrate 100, the first switching line SL1, the driving voltage line VL and the first switching TFT ST1 are formed in portion “B” of a first substrate 110. The first switching line SL1 and the driving voltage line VL may include, but are not limited to, a first metal material and may be formed on the first substrate 110.

A gate electrode ST1-G of the first switching TFT ST1 is branched from the first switching line SL1, such that the gate electrode ST1-G is wider than the first switching line SL1. The gate insulating layer 121 covers the first switching line SL1 and the gate electrode ST1-G.

In exemplary embodiments, a source electrode ST1-S and a drain electrode ST1-D of the first switching TFT ST1 include, but are not limited to, a second metal material and are formed on the gate insulating layer 121. The source electrode ST1-S is spaced apart from the drain electrode ST1-D in an area on which the gate electrode ST1-G is formed.

The organic insulating layer 122 covers the source electrode ST1-S and the drain electrode ST1-D. The organic insulating layer 122 may have a first contact hole 122a through which the source electrode ST1-S is partially exposed, a second contact hole 122b through which the drain electrode ST1-D is partially exposed, and a third contact hole 122c through which the driving voltage line VL is partially exposed.

Referring to FIG. 6, the sensing electrode SE and a first bridge electrode BE1 are formed on the organic insulating layer 122. The sensing electrode SE is electrically connected to the source electrode ST1-S through the first contact hole 122a. The first bridge electrode BE1 is electrically connected to the drain electrode ST1-D through the second contact hole 122b and the driving voltage line VL through the third contact hole 122c. The drain electrode ST1-D may be electrically connected to the driving voltage line VL via the first bridge electrode BE1. The first bridge electrode BE1 has a transmissive bridge electrode TEb that may include, but is not limited to, a transparent and conductive material. The first bridge electrode BE1 may also have a reflective bridge electrode REb that may include, but is not limited to, a reflective material.

FIG. 7 is a layout showing portion “C” of an array substrate in FIG. 2.

Referring to FIG. 7, in the array substrate 100, the second switching line SL2, the output line OL and the second switching TFT ST2 are formed on portion “C” of the first substrate 110.

In exemplary embodiments, the second switching line SL2 and the output line OL are formed on the first substrate 110 and may include, but are not limited to, a first metal material. A gate electrode ST2-G of the second switching TFT ST2 is branched from the second switching line SL2, such that the gate electrode ST2-G has a width larger than that of the second switching line SL2.

A source electrode ST2-S and a drain electrode ST2-D of the second switching TFT ST2 may include, but are not limited to, a second metal material. The source electrode ST2-S is spaced apart from the drain electrode ST2-D in an area on which the gate electrode ST2-G is formed.

The drain electrode ST2-D of the second switching TFT ST2 is electrically connected to the sensing electrode SE, and the source electrode ST2-S of the second switching TFT ST2 is electrically connected to the output line OL via a second bridge electrode BE2.

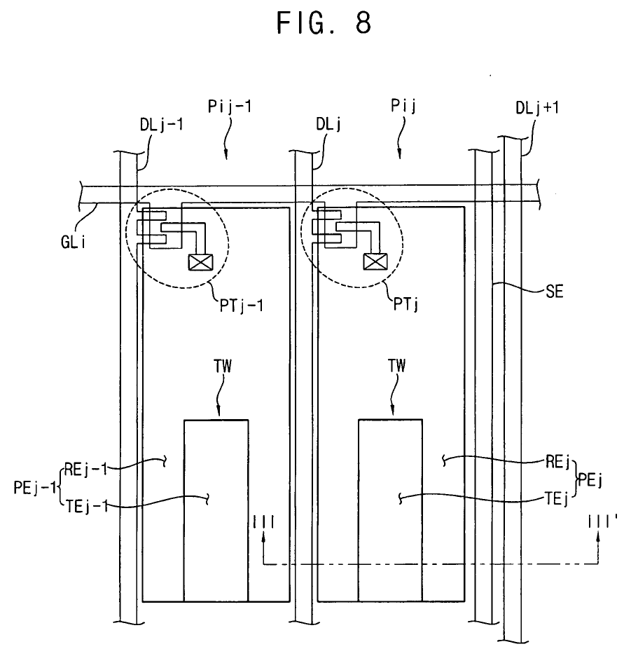

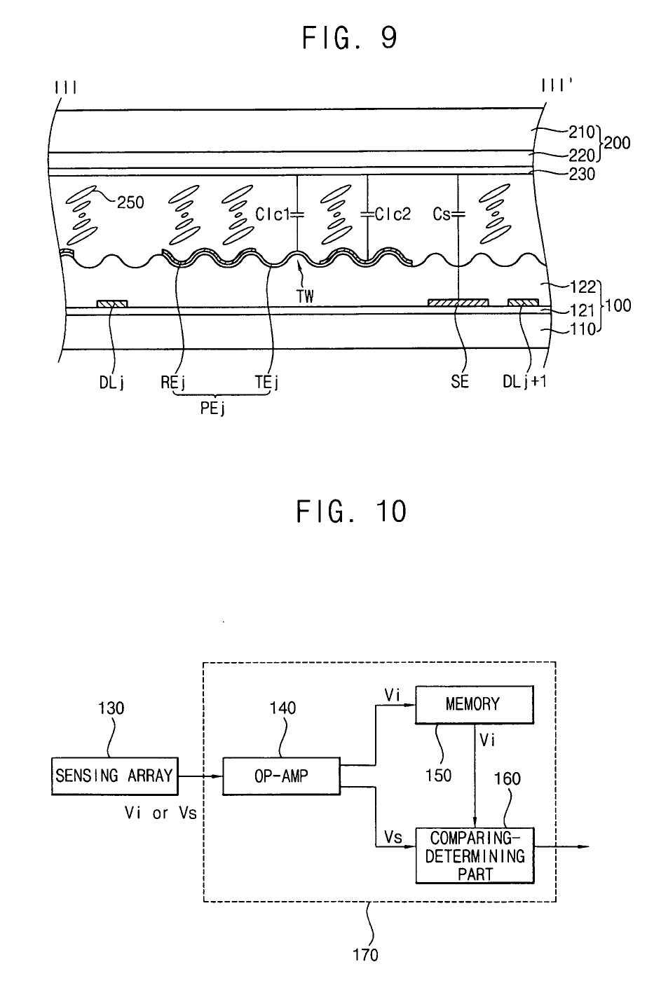

FIG. 8 is a layout showing an exemplary embodiment of an array substrate corresponding to portion “A” in FIG. 2 according to the present invention. FIG. 9 is a cross-sectional view taken along line III-III′ in FIG. 8. In FIGS. 8 and 9, the same reference numerals denote the same elements in FIGS. 3 and 4, and thus any further repetitive descriptions of the same elements will be omitted.

Referring to FIGS. 8 and 9, in the exemplary embodiment of an array substrate 100 according to the present invention, the {i×(j−1)}-th pixel Pij−1 and the (i×j)-th pixel Pij are formed on portion “A” of the first substrate 110.

The sensing electrode SE is formed at one side of the (i×j)-th pixel Pij. The sensing electrode SE may be disposed between the j-th pixel electrode PEj and the (j+1 )-th data line DLj+1.

Referring to FIG. 9, the i-th gate line (not shown) including, but is not limited to, a first metal material, is formed on the first substrate 110. The gate insulating layer 121 is formed on the first substrate 110 on which the i-th gate line is formed. The j-th and (j+1 )-th data lines DLj and DLj+1 may include, but are not limited to, a second metal material, and are formed on the gate insulating layer 121. The sensing electrode SE may include the second metal material and is formed on the gate insulating layer 121. In exemplary embodiments, the sensing electrode SE and the j-th and (j+1 )-th data lines DLj and DLj+1 may be formed on a same layer.

The organic insulating layer 122 is formed on the gate insulating layer 121 and the j-th and (j+1)-th data lines DLj and DLj+1. The j-th transmission electrode TEj may be formed on the organic insulating layer 122 in a uniform thickness. The j-th reflection electrode REj may be formed on the j-th transmission electrode TEj in a uniform thickness and have a transmission window TW through which the j-th transmission electrode TEj is partially exposed.

In exemplary embodiments, the j-th transmission electrode TEj and j-th reflection electrode REj are removed from an area on which the sensing electrode SE is formed. That is, the j-th transmission electrode TEj and j-th reflection electrode REj are not formed between the sensing electrode SE and a common electrode 230 of the opposite substrate 200. The sensing electrode SE of the sensing capacitor Cs faces the common electrode 230 of the opposite substrate 200 and the liquid crystal layer 250 is disposed between the sensing electrode SE and the common electrode 230.

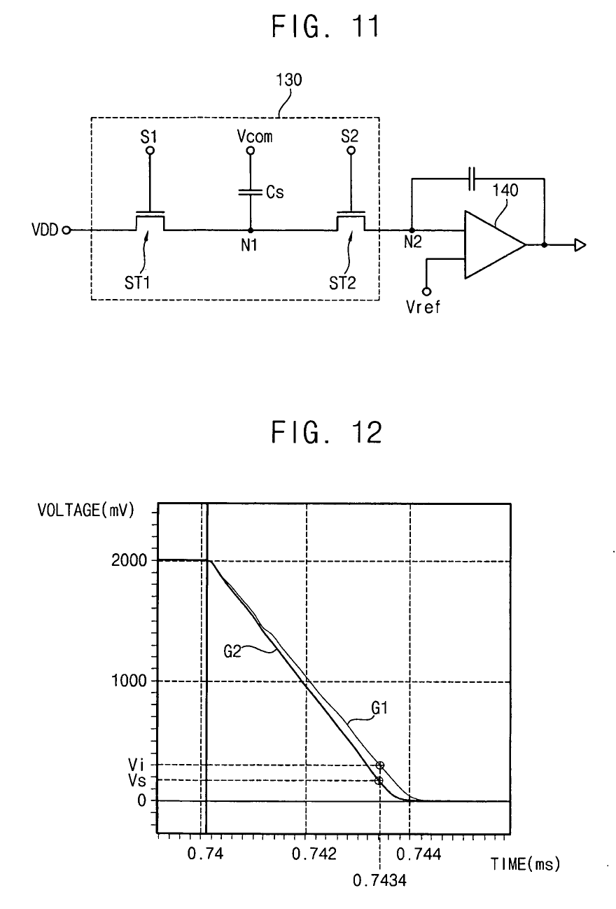

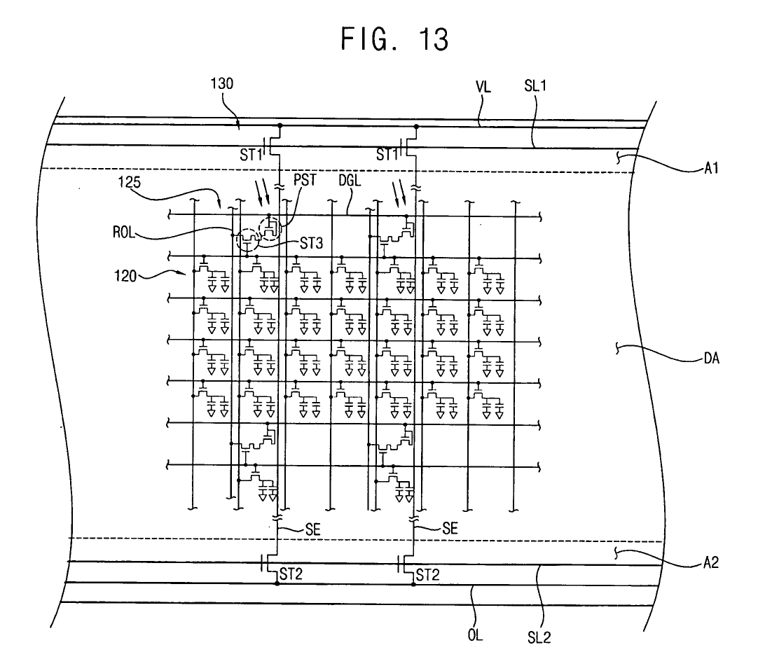

FIG. 10 is a block diagram illustrating an exemplary embodiment of a sensing array and a control part of the display apparatus in FIG. 1. FIG. 11 is a circuit diagram illustrating an exemplary embodiment of the sensing array in FIG. 10. FIG. 12 is a graph illustrating an output voltage of an exemplary embodiment of an operational amplifier in FIG. 10. In FIG. 12, an X-axis represents a time in milliseconds (ms) and a Y-axis represents a voltage in millivolts (mV).

Referring to FIG. 10, a sensing array 130 is formed on a display panel (not shown) and outputs an initial voltage Vi and a sensing voltage Vs. The sensing array 130 outputs the initial voltage Vi based on an initial thickness of a liquid crystal layer (not shown) during an initialization time and the sensing voltage Vs based on a varied thickness of the liquid crystal layer during a sensing time.

A control part 170 includes an operational amplifier (OP-AMP) 140, a memory 150, and a comparing-determining part 160. The OP-AMP 140 is electrically connected to the sensing array 130 and provides the memory 150 with the initial voltage Vi from the sensing array 130. The memory 150 stores the initial voltage Vi outputted from the sensing array 130.

The OP-AMP 140 provides the comparing-determining part 160 with the sensing voltage Vs from the sensing array 130. The comparing-determining part 160 compares the initial voltage Vi from the memory 150 with the sensing voltage Vs from the OP-AMP 140 to detect a voltage difference between the initial voltage Vi and the sensing voltage Vs. The comparing-determining part 160 compares the voltage difference with a predetermined reference voltage. Based on the compared result, the comparing-determining part 160 determines whether or not external force is supplied to the display panel. In exemplary embodiments, when the voltage difference between the sensing voltage Vs and the initial voltage Vi is larger than the reference voltage, the comparing-determining part 160 generates information indicating a position to which the external force is applied to the display panel.

Referring to FIG. 12, G1 represents an initial voltage in response to an initial thickness of the liquid crystal layer during an initializing time, and G2 represents a sensing voltage in response to a varied thickness of the liquid crystal layer due to an external force during a sensing time.

As shown in the exemplary embodiment of FIG. 12, at 0.7434 milliseconds (ms), the initial voltage Vi has a voltage level of about 301 mV and the sensing voltage Vs has a voltage level of about 177 mV lower than the initial voltage Vi. Therefore, the voltage difference between the sensing voltage Vs and the initial voltage Vi is about 124 mV at 0.7434 milliseconds (ms).

An exemplary embodiment of an operating principle of the sensing array will be described below with reference to FIG. 11.

Referring to FIG. 11, the first switching TFT ST1 has a gate electrode to which a first switching signal S1 is applied, a drain electrode to which a driving voltage VDD is applied and a source electrode connected to a first node N1. The second switching TFT ST2 has a gate electrode to which a second switching signal S2 is applied, a drain electrode connected to the first node N1 and a source electrode connected to a second node N2. The first electrode of a sensing capacitor Cs is electrically connected to the first node N1, and a second electrode of the sensing capacitor Cs receives a common voltage Vcom. A first input terminal of the OP-AMP 140 is electrically connected to the second node N2, and a second input terminal of the OP-AMP 140 receives a reference voltage Vref.

When the first switching TFT ST1 is turned on in response to the first switching signal S1 and the driving voltage VDD during an initializing time, an electric potential of the first node N1 gradually increases to the initial voltage Vi by the sensing capacitor Cs. The second switching TFT ST2 is turned on in response to the second switching signal S2, an electric potential of the second node N2 increases to the initial voltage Vi. The OP-AMP 140 receives the initial voltage Vi and the reference voltage Vref. The OP-AMP 140 amplifies the initial voltage Vi by the reference voltage Vref and outputs the amplified initial voltage Vi. The amplified initial voltage Vi is stored in the memory 150 (refer to FIG. 10).

In exemplary embodiments, when the first and second switching signals S1 and S2 are maintained in a low level and the thickness of the liquid crystal layer varies during the sensing time, the electric potential of the first node N1 varies by the sensing capacitor Cs. The thickness of the liquid crystal layer is reduced due to the external force, and the electric potential of the first node N1 is changed into the sensing voltage Vs having a lower voltage level than the initial voltage Vi. When the second switching TFT ST2 is turned on in response to the second switching signal S2, the electric potential of the second node N2 is changed into the sensing voltage Vs. The OP-AMP 140 receives the sensing voltage Vs and the reference voltage Vref and amplifies the sensing voltage Vs by the reference voltage Vref to output the amplified sensing voltage Vs.

FIG. 13 is a circuit diagram showing an exemplary embodiment of a display panel according to the present invention. In FIG. 13, the same reference numerals denote the same elements in FIG. 2, and thus any further repetitive descriptions of the same elements will be omitted.

Referring to FIG. 13, the display panel includes the pixel array 120, a photo sensing array 125 and the sensing array 130 formed thereon.

The photo sensing array 125 is disposed in the display area DA of the display panel and includes a photo sensing TFT PST, a third switching TFT ST3, a dummy gate line DGL and a readout line ROL. The dummy gate line DGL is extended in a direction substantially parallel with the gate lines GL1 to GLn, and the readout line ROL is extended in a direction substantially parallel with the data lines DL1 to DLm. The photo sensing TFT PST includes gate and drain electrodes electrically connected to the dummy gate line DGL and a source electrode of the photo sensing TFT PST electrically connected to the third switching TFT ST3. The third switching TFT ST3 includes a drain electrode electrically connected to the source electrode of the photo sensing TFT PST, a gate electrode electrically connected to a corresponding gate line and a source electrode electrically connected to the readout line ROL.

In exemplary embodiments, a driving voltage to turn on the photo sensing TFT PST is applied to the dummy gate line DGL while the photo sensing TFT PST receives a light from an external source, such as a light pen. The photo sensing TFT PST outputs a photocurrent corresponding to brightness of the light, and the photocurrent is applied to the third switching TFT ST3. When a gate signal is applied to a corresponding gate line, the third switching TFT ST3 provides the readout line ROL with the photocurrent in response to the gate signal. The photocurrent is applied to the control part 170 (refer to FIG. 10) via the readout line ROL, and the control part 170 generates information indicating a position to which the light is supplied from the external source based on the photocurrent.

In another exemplary embodiment, the sensing array 130 senses a varied thickness of a liquid crystal layer when the light pen makes contact with the display panel. When a thickness of the liquid crystal layer is reduced due to touch of the light pen on the display panel, the sensing array 130 outputs a sensing voltage Vs (refer to FIG. 12) having a voltage level lower than that of an initial voltage Vi (refer to FIG. 12). The control part 170 compares the sensing voltage Vs with the initial voltage Vi and determines whether external force is applied to the display panel or not. Advantageously, the control part 170 may generate accurate positional information using the photocurrent and the varied thickness of the liquid crystal layer, thereby improving sensing ability to an external signal inputted through the display panel of the display apparatus.

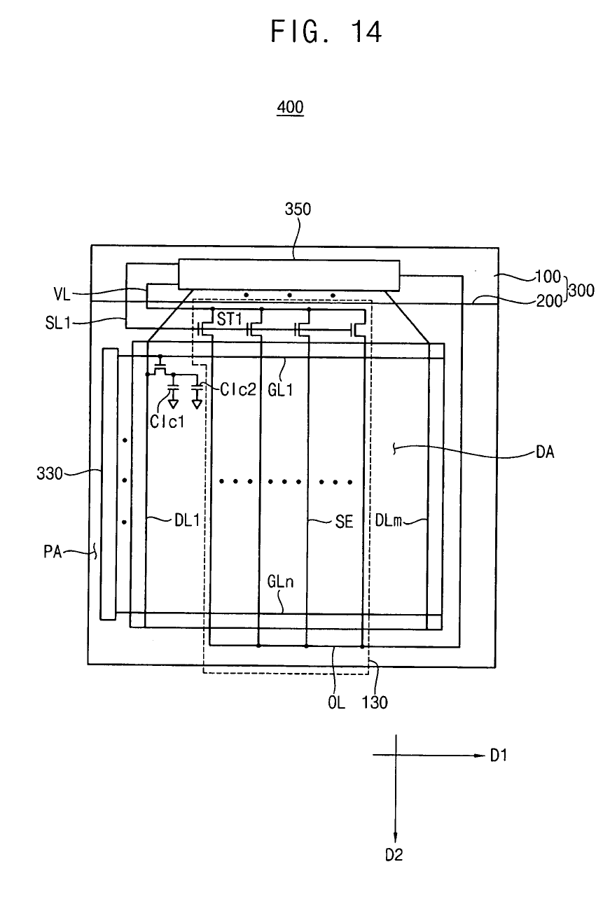

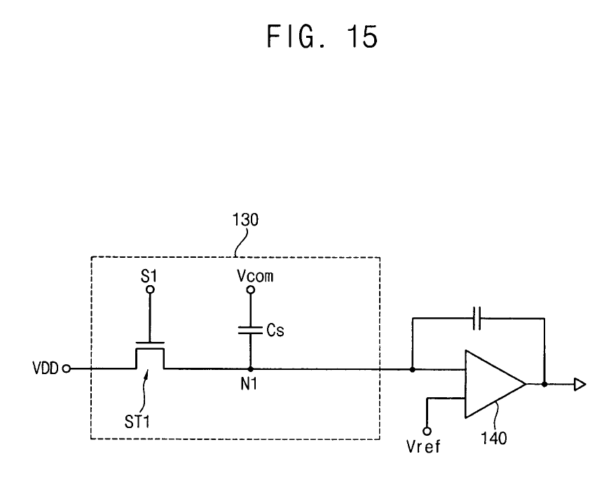

FIG. 14 is a plan view showing another exemplary embodiment of a display apparatus according to the present invention. FIG. 15 is a circuit diagram illustrating an exemplary embodiment of a sensing array and an operational amplifier in FIG. 14. In FIG. 14, the same reference numerals denote the same elements in FIG. 1, and thus any further repetitive descriptions of the same elements will be omitted.

Referring to FIGS. 14 and 15, the sensing array 130 includes the sensing electrode SE and the first switching TFT ST1. The sensing electrode SE is formed in the display area DA of the first substrate 110 and extended in a direction substantially parallel with the data lines DL1 to DLm.

The first switching TFT ST1 is formed in the peripheral area PA of the first substrate 110. The first switching TFT ST1 is disposed adjacent to a first end portion of the data lines DL1 to DLm.

In exemplary embodiments, the sensing array 130 further includes the driving voltage line VL, the first switching line SL1 and the output line OL disposed in the peripheral area PA. The first switching TFT ST1 may include a gate electrode electrically connected to the first switching line SL1, a drain electrode electrically connected to the driving voltage line VL, and a source electrode electrically connected to a first end portion of the sensing electrode SE. A second end portion of the sensing electrode SE is electrically connected to the output line OL. The sensing electrode SE faces the common electrode to which a common voltage is applied, and the liquid crystal layer is disposed between the sensing electrode SE and the common electrode. A sensing capacitor Cs may be defined by the sensing electrode SE, the liquid crystal layer and the common electrode.

The sensing array 130 outputs the initial voltage Vi (refer to FIG. 12) during the initializing time and the sensing voltage Vs having a lower voltage than the initial voltage (refer to FIG. 12) during the sensing time. The initializing time may indicate a time before a user touches the display panel, and the sensing time may indicate a time while the user touches the display panel. The OP-AMP 140 receives the sensing voltage Vs and the reference voltage Vref and amplifies the sensing voltage Vs by the reference voltage Vref during the sensing time.

Referring to FIG. 15, the first switching TFT ST1 may be turned on in response to the first switching signal S1 and the driving voltage VDD during the initializing time. When the common voltage Vcom is applied to the common electrode, an electric potential of the first node N1 gradually increases to the initial voltage Vi by the sensing capacitor Cs. In alternative embodiments embodiment, the common voltage Vcom or the first switching signal may have an alternating current voltage, or the driving voltage VDD or the common voltage Vcom may have an alternating current voltage.

In other exemplary embodiments, when the thickness of the liquid crystal layer varies due to the touch of the user during the sensing time, the electric potential of the first node N1 varies. Since the thickness of the liquid crystal layer is reduced when the user touches the display panel, the electric potential of the first node N1 is changed into the sensing voltage Vs having a lower voltage level than the initial voltage Vi.

The control part 170 (refer to FIG. 10) compares the sensing voltage Vs with the initial voltage Vi and determines whether or not external force is applied to the display panel. Advantageously, the control part 170 may generate accurate information indicating a position to which the external force is applied based on the varied thickness of the liquid crystal layer.

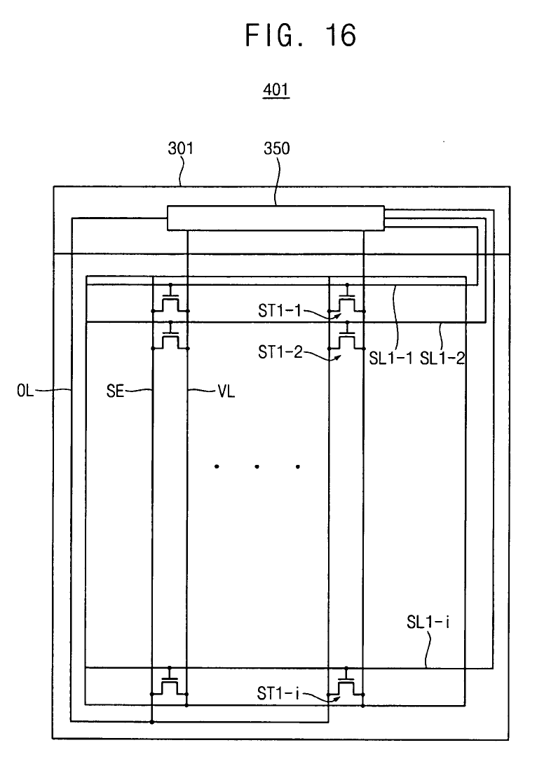

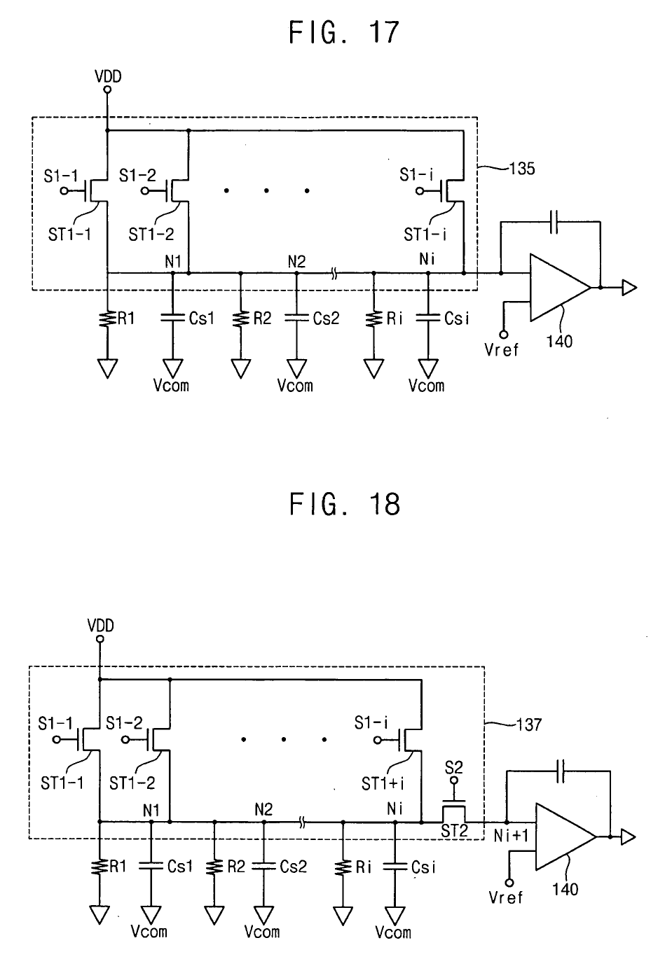

FIG. 16 is a plan view showing another exemplary embodiment of a display apparatus according to the present invention. FIG. 17 is a circuit diagram illustrating an exemplary embodiment of a sensing array and an operational amplifier in FIG. 16. In FIG. 16, the same reference numerals denote the same elements in FIG. 14, and thus any further repetitive descriptions of the same elements will be omitted.

Referring to FIGS. 16 and 17, a sensing array 135 is disposed on the display panel 301 of the display apparatus 401. The sensing array 135 includes the sensing electrode SE, the driving voltage line VL, the output line OL, a first sub switching line SL1−1 to an i-th sub switching line SL1−i, and a first sub switching TFT ST1−1 to an i-th sub switching TFT ST1−i.

Drain electrodes of the first switching TFT ST1−1 to the i-th sub switching TFT ST1−i may be connected to the driving voltage line VL, gate electrodes of the first switching TFT ST1−1 to the i-th sub switching TFT ST1−i may be electrically connected to the first sub switching line SL1−1 to the i-th sub switching line SL1−i, respectively, and source electrodes of the first sub switching TFT ST1−1 to the i-th sub switching TFT ST1−i may be connected to the sensing electrode SE. The driving voltage VDD may be applied to the driving voltage line VL, and a first sub switching signal S1−1 to an i-th sub switching signal S1−i may be sequentially applied to the first sub switching line SL1−1 to the i-th sub switching line SL1−i.

In exemplary embodiments, the sensing electrode SE faces a common electrode, and the liquid crystal layer (not shown) may be disposed between the sensing electrode SE and the common electrode. Each of the first to the i-th sensing capacitors Cs1 to Csi may include the sensing electrode SE, the liquid crystal layer and the common electrode. The first sensing capacitor Cs1 to the i-th sensing capacitor Csi may be electrically connected to the first sub switching TFT ST1−1 to the i-th sub switching TFT ST1−i, respectively. The first resistor R1 to the i-th resistor Ri may also be connected to the first to the i-th sensing capacitors Cs1 to Csi in parallel.

When the first sub switching signal S1−1 to the i-th sub switching signal S1−i are sequentially applied to the first sub switching line SL1−1 to the i-th sub switching line SL1−i while the driving voltage VDD is applied to the driving voltage line VL, the first sub switching TFT ST1−1 to the i-th sub switching TFT ST1−i are sequentially turned on in response to the first sub switching signal S1−1 to the i-th sub switching signal S1−i.

In the sensing array 135, electric potentials of first to i-th nodes N1 to Ni gradually increase to the first to the i-th initial voltages in response to the first to the i-th switching signals S1−1 to S1−i during the initializing time.

When the first sub switching signal S1−1 to the i-th sub switching signal S1−i are applied to the first sub switching TFT ST1−1 to the i-th sub switching TFT ST1−i, respectively, the electric potentials of the first to i-th nodes N1 to Ni are changed into first to i-th sensing voltages during the sensing time. In exemplary embodiments, the first to the i-th sensing voltages have a voltage level smaller than the first to the i-th initial voltages.

The control part 170 of the display apparatus 401 may compare the first to the i-th sensing voltages with the first to the i-th initial voltages and determine whether or not external force is applied to the display panel 301. Advantageously, the control part 170 may generate accurate information indicating a position to which the external force is applied, based on the varied thickness of the liquid crystal layer.

In alternative exemplary embodiments, the sensing array 135 may further include first to i-th dummy switching TFTs (not shown) that are connected to the first to i-th sub switching TFTs ST1−1 to ST1−i in series.

FIG. 18 is a circuit diagram illustrating another exemplary embodiment of a sensing array according to the present invention. In FIG. 18, the same reference numerals denote the same elements in FIG. 17, and thus any further repetitive descriptions of the same elements will be omitted.

Referring to FIG. 18, a sensing array 137 includes the sensing electrode SE, the driving voltage line VL, the output line OL, the first sub switching line SL1−1 to the i-th sub switching line SL1−i, the first sub switching TFT ST1−1 to the i-th sub switching TFT ST1−i and a second switching TFT ST2.

Drain electrodes of the first sub switching TFT ST1−1 to the i-th sub switching TFT ST1−i may be connected to the driving voltage line VL, gate electrodes of the first sub switching TFT ST1−1 to the i-th sub switching TFT ST1−i may be electrically connected to the first sub switching line SL1−1 to the i-th sub switching line SL1−i, respectively, and source electrodes of the first sub switching TFT ST1−1 to the i-th sub switching TFT ST1−i may be connected to the sensing electrode SE.

The second switching TFT ST2 may include a drain electrode electrically connected to the sensing electrode SE. A gate electrode to which a second switching signal S2 is applied and a source of the second switching TFT ST2 may also be electrically connected to an i+1-th node Ni+1.

In exemplary embodiments, the second switching TFT ST2 outputs the first to the i-th initial voltages during the initializing time and the first to the i-th sensing voltages during the sensing time in response to the second switching signal S2 during the sensing time.

In the exemplary embodiments discussed above, the sensing array is disposed on the array substrate of the display panel, and the sensing array includes a sensing electrode facing the common electrode and the switching TFT outputting the sensing voltage.

Advantageously, the display apparatus may generate accurate information indicating a position to which the external force is applied, based on the varied thickness of the liquid crystal layer, thereby improving a sensing ability to the external signal of the display apparatus.

In other exemplary embodiments discussed above, the photo sensing array and the sensing array are disposed on the array substrate. Advantageously, the display apparatus may generate more accurate positional information than if only the photo sensing array is disposed on the array substrate.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel including an array substrate having a pixel electrode, an opposite substrate having a common electrode facing the pixel electrode and a liquid crystal layer disposed between the array substrate and the opposite substrate;
a sensing array configured to output an initial voltage in response to an initial thickness of the liquid crystal layer during an initializing time and a sensing voltage in response to a varied thickness of the liquid crystal layer due to an external force during a sensing time, the sensing array being formed on the display panel; and
a control part configured to compare the sensing voltage with the initial voltage, to determine whether or not the external force is applied to the display panel and generate information indicating a position to which the external force is applied.

2. The display apparatus of claim 1, wherein the sensing array comprises:
a sensing electrode facing the common electrode, the liquid crystal layer disposed between the sensing electrode and the common electrode;
a first switching device electrically connected to the sensing electrode configured to provide the sensing electrode with the initial voltage in response to a first switching signal and a driving voltage; and
a second switching device electrically connected to the sensing electrode configured to output the initial voltage applied to the sensing electrode during the initializing time and the sensing voltage applied to the sensing electrode during the sensing time in response to a second switching signal.

3. The display apparatus of claim 2, wherein the first switching device comprises:
a first electrode to receive the driving voltage;
a second electrode configured to receive the first switching signal during the initializing time; and
a third electrode electrically connected to the sensing electrode, and
wherein the second switching device comprises:
a fourth electrode electrically connected to the sensing electrode;
a fifth electrode configured to receive the second switching signal during the sensing time; and
a sixth electrode electrically connected to the control part.

4. The display apparatus of claims 3, further comprising:
a gate insulating layer disposed on the second electrode of the first switching device, the first and the third electrode of the first switching device formed on the gate insulating layer;
an organic insulating layer disposed on the first and the third electrode of the first switching device, the sensing electrode disposed on the organic insulating layer;
and a bridge electrode disposed on the organic insulating layer, the bridge electrode electrically connected to the third electrode of the first switching device.

5. The display apparatus of claim 3, wherein the sensing array further comprises:
a driving voltage line electrically connected to the first electrode of the first switching device, the driving voltage providing the first electrode with the driving voltage;
a first switching line electrically connected to the second electrode of the first switching device, the first switching line providing the second electrode with the first switching signal;
a second switching line electrically connected to the fifth electrode of the second switching device, the second switching line providing the fifth electrode with the second switching signal; and
an output line electrically connected to the sixth electrode of the second switching device, the output line outputting the initial voltage and the sensing voltage.

6. The display apparatus of claim 2, wherein the array substrate comprises:
a first substrate divided into a display area and a peripheral area adjacent to the display area; and
a pixel array in the display area of the first substrate.

7. The display apparatus of claim 6, wherein the sensing electrode is disposed in the display area of the first substrate, and the first and second switching devices are disposed in the peripheral area of the first substrate.

8. The display apparatus of claim 6, wherein the pixel array comprises:
a gate line;
a data line intersected with and electrically insulated from the gate line; and
a pixel switching device electrically connected to the gate line and the data line, wherein the pixel electrode is electrically connected to the pixel switching device.

9. The display apparatus of claim 8, wherein the sensing electrode comprises a same material as the data line and the sensing electrode and the data line are formed from a same layer.

10. The display apparatus of claim 9, wherein the pixel electrode comprises an opening corresponding to an area in which the sensing electrode is formed.

11. The display apparatus of claim 10, wherein the sensing electrode is extended substantially parallel with the data line, the first switching device is disposed in a first area adjacent to a first end portion of the data line of the peripheral area, and the second switching device is disposed in a second area adjacent to a second end portion of the data line of the peripheral area.

12. The display apparatus of claim 8, wherein the sensing electrode comprises a same material as the pixel electrode, and the sensing electrode and the pixel electrode are formed from a same layer.

13. The display apparatus of claim 12, wherein the pixel electrode comprises:
a transmission electrode having a transparent and conductive material; and
a reflection electrode on the transmission electrode, the reflection electrode having a reflective material.

14. The display apparatus of claim 12, wherein the sensing electrode comprises:
a sensing transmission electrode having a transparent and conductive material; and
a sensing reflection electrode on the transmission electrode, the reflection electrode having a reflective material.

15. The display apparatus of claim 14, wherein the reflection electrode is formed in a uniform thickness on the transmission electrode and the sensing reflection electrode is formed in a uniform thickness on the sensing transmission electrode.

16. The display apparatus of claim 1, further comprising a photo sensing array on the array substrate, the photo sensing array configured to receive a light from an input member that makes contact with a surface of the display panel and to output a photo current in response to brightness of the light.

17. The display apparatus of claim 16, wherein the array substrate comprises:
a gate line configured to receive a gate signal;
a data line that intersects with and is electrically insulated from the gate line and configured to receive a data signal; and
a pixel switching device electrically connected to the gate line and the data line, the pixel switching device configured to receive the gate signal and the data signal,
wherein the pixel electrode is electrically connected to the pixel switching device.

18. The display apparatus of claim 17, wherein the photo sensing array comprises:
a dummy gate line configured to receive a dummy gate voltage;
a photo sensing device electrically connected to the dummy gate line and configured to output the photocurrent corresponding to the brightness of the light in response to the light and the dummy gate voltage;
a third switching device configured to output the photocurrent in response to the gate signal from the gate line; and
a readout line configured to provide the control part with the photocurrent.

19. The display apparatus of claim 1, wherein the sensing array comprises:
a sensing electrode on the array substrate, the sensing electrode facing the common electrode and the liquid crystal layer being disposed between the sensing electrode and the common electrode to form a sensing capacitor; and
a first switching device configured to charge the sensing capacitor in response to a first switching signal and a driving voltage, the first switching device being electrically connected to the sensing electrode, and
wherein the common electrode receives a common voltage.

20. The display apparatus of claim 19, wherein the common voltage, the driving voltage, or both has an alternating current voltage.

21. The display apparatus of claim 20, wherein the first switching signal, the common voltage, or both has an alternating current voltage.

22. The display apparatus of claim 19, wherein the first switching device comprises a transistor having a first electrode to which the driving voltage is applied, a second electrode to which the first switching signal is applied during the initializing time and a third electrode electrically connected to the sensing electrode.

23. The display apparatus of claim 22, wherein the sensing array comprises:
a driving voltage line configured to provide the first electrode of the first switching device with the driving voltage;
a switching line configured to provide the second electrode of the first switching device with the first switching signal; and
an output line electrically connected to the sensing electrode and configured to output the sensing voltage and the initial voltage.

24. The display apparatus of claim 19, further comprising an operational amplifier configured to amplify the initial voltage supplied to the operational amplifier by a reference voltage supplied to the operational amplifier during the initializing time and to amplify the sensing voltage supplied to the operational amplifier by the reference voltage during the sensing time.

25. The display apparatus of claim 1, wherein the sensing array comprises:
a sensing electrode on the array substrate and facing the common electrode, wherein the liquid crystal layer is formed between the sensing electrode and the common electrode;
a plurality of sub switching lines on the array substrate and intersecting with and electrically insulated from the sensing electrode to sequentially receive a plurality of sub switching signals; and
a plurality of sub switching devices having a first electrode electrically connected to the sensing electrode, a second electrode electrically connected to a corresponding switching line of the switching lines and a third electrode to which the driving voltage is applied, the sub switching device being sequentially turned on in response to the sub switching signal.

26. The display apparatus of claim 25, wherein the sensing array further comprises a driving voltage line connected to the third electrodes of the sub switching devices to provide the third electrode with the driving voltage.

27. The display apparatus of claim 25, wherein the sensing array further comprises a second switching device having a first electrode connected to the sensing electrode, a second electrode to receive a second switching signal and a third electrode to output the sensing voltage.

28. The display apparatus of claim 1, wherein the control part comprises:
an operational amplifier configured to amplify the initial voltage supplied to the operational amplifier by a reference voltage supplied to the operational amplifier during the initializing time and the sensing voltage supplied to the operational amplifier by the reference voltage during the sensing time;
a memory configured to store the initial voltage amplified by the operational amplifier; and
a comparing-determining part configured to compare the sensing voltage from the OP-AMP with the initial voltage from the memory, determine whether or not the external force is applied to the display panel, and generate information indicating a position to which the external force is applied.

29. A method of driving a display apparatus, the method comprising:
generating an initial voltage in response to an initial thickness of a liquid crystal layer during an initializing time;
generating a sensing voltage in response to a varied thickness of the liquid crystal layer due to an external force during a sensing time;
comparing the initial voltage with the sensing voltage to determine whether or not the external force is applied to a display panel; and
generating information indicating a position to which the external force is applied on the display panel.

30. The method of claim 29, wherein the comparing comprises:
generating a voltage difference between the sensing voltage and the initial voltage; and
comparing the voltage difference with a predetermined reference voltage.
